(19) United States
(12) Patent Application Publication
(10) Pub. No.: US 2005/0018903 A1
(43) Pub. Date: Jan. 27, 2005

(54) Method and apparatus for image processing and computer product

(76) Inventors: Noriko Miyagi, Kanagawa (JP); Satoshi Ouchi, Tokyo (JP); Hiroyuki Shibaki, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/897,625

(22) Filed: Jul. 23, 2004

(30) Foreign Application Priority Data
Jul. 24, 2003 (JP) 2003-201167

(51) Int. Cl. G06K 9/00; B41J 1/00

(52) U.S. Cl. 382/167; 358/1.9

(57) ABSTRACT

The image data is supplied to an edge detecting unit that acquires edge information as an attribute signal indicating the attribute of the image. The edge information is supplied to a first through a third correcting units where the edge information is corrected to the signals indicating different attributes in the respective correcting units to be supplied to a filter processor, a UCR/black generating unit, a γ-correcting unit, and a pseudo halftone unit, each of which performs various image processings. Image processings according to different attributes of the image supplied from the respective correcting units are performed, respectively.

The present application claims priority to the corresponding Japanese Application No. 2003-201167 filed on Jul. 24, 2003, the entire contents of which are hereby incorporated by reference.

### BACKGROUND OF THE INVENTION

1. Field of the Invention

The present invention relates to a technology for performing image processing based on an attribute of image data.

2. Description of the Related Art

There has been conventionally used an image processing apparatus that performs various image processings on digital image data obtained by reading an image with a scanner. The image processing performed by the image processing apparatus is performed, for example, in order to improve the quality of an image in printing, displaying, etc. There is proposed an image processing apparatus that acquires the characteristic amount of image data and performs image processing based on the acquired characteristic amount in order to obtain the image having a higher quality (e.g. see Japanese Patent Application Laid-Open No. 2001-14458).

The image processing apparatus described in the Japanese Patent Application Laid-Open No. 2001-14458 acquires the edge amount of an edge as the characteristic amount of the image data, and corrects the edge amount to values corresponding to various image processings for use. For example, while the acquired edge amount is corrected such that the edge changes relatively steeply in a filter processing, the acquired edge amount is corrected such that the edge changes relatively gently in an under color removal processing. The edge amount is corrected for use according to each processing in this manner so that each image processing can be made more appropriate.

Further, there has been proposed an apparatus that acquires information on an attribute of image data other than acquiring the characteristic amount such as the edge amount from the image data as described above, and performs image processing based on the acquired information.

For example, there have been proposed an apparatus that acquires information indicating whether or not a character inside area is defined as a pattern area inside a character area within an image corresponding to image data, and uses the same for an image processing (e.g. see Japanese Patent Application Laid-Open No. 2000-134471), and an apparatus that acquires information on a line width of an edge within an image corresponding to image data, and performs image processing based on the acquired information (e.g. see Japanese Patent Application Laid-Open No. 11-266367).

However, in the image processing apparatus, various image processings are performed on the image data in many cases, and there are various items of information on attributes of an image to be processed, which are required to be reflected on the contents of each image processing in order to obtain the image having a higher quality. Therefore, in some cases, it is not sufficient that the edge amount of the image to be processed is corrected in terms of its increase and decrease and the corrected edge amount is reflected on the content decision in each image processing.

Further, even when the information on the attribute of the image to be processed, such as whether or not the image is a character inside area, is used, and even when the information on the attribute can be reflected on the processing contents to perform suitable image processing in a certain type of image processing, the processing on which the information on the attribute is reflected is not necessarily suitable for other image processing.

### SUMMARY OF THE INVENTION

A method and apparatus for image processing, and computer product are described. The image processing apparatus comprises an attribute acquiring unit that acquires an attribute signal that indicates an attribute of image data, a correcting unit that corrects the attribute signal to obtain a plurality of attribute signals each of which indicates an attribute different from the attribute indicated by the attribute signal, and an image processing unit that performs a plurality of image processings on the image data based on each of the attribute signals obtained.

### BRIEF DESCRIPTION OF THE DRAWINGS

FIG. 1 is a block diagram of an image processing apparatus according to one embodiment of the present invention;

FIG. 2 is a detailed block diagram of an edge detecting unit in the image processing apparatus shown in FIG. 1;

FIGS. 3A to 3D are examples edge amount detection filters;

FIG. 4 is a block diagram of a first correcting unit in the image processing apparatus shown in FIG. 1;

FIG. 5 is a diagram to explain contents of a decision processing by a line width deciding unit in the first correcting unit shown in FIG. 4;

FIG. 6 is a diagram to explain contents of a decision processing by an overall deciding unit in the first correcting unit shown in FIG. 4;

FIG. 7 is a block diagram of a filter processor that is a component of the image processing apparatus shown in FIG. 1;

FIG. 8 is a diagram to explain contents of filter characteristics (relationship between amplitude and spatial frequency) that the filter processor may employ;

FIG. 9 is a diagram to explain contents of a filter processing by the filter processor for a thin line edge and a filter processing by the filter processor for a thick line edge;

FIG. 10 is a block diagram of a second correcting unit in the image processing apparatus shown in FIG. 1;

FIG. 11 is a diagram to explain contents of a decision processing as to whether or not an image to be processed is a character inside area by a character inside deciding unit in the second correcting unit;

FIG. 12 is a diagram to explain contents of a LUT for black generation processing owned by a UCR/black generation unit in the image processing apparatus shown in FIG. 1;

FIG. 13 is a diagram to explain an occurrence factor of white void when only an edge of a black character is reproduced in a “K” color and the inside thereof is reproduced in CMY;

FIG. 14 is a block diagram of a third correcting unit in the image processing apparatus shown in FIG. 1;

FIG. 15 is a diagram to explain contents of a correction table owned by a γ-correcting unit 16 that is a component of the image processing apparatus;

FIG. 16 is a block diagram of an image processing apparatus according to one embodiment of the present invention;

FIG. 17 is a block diagram to explain a structure example of a code embedding unit in the image processing apparatus shown in FIG. 16;

FIG. 18 is a block diagram to explain a structure example of a code extracting unit in the image processing apparatus shown in FIG. 16; and

FIG. 19 is a diagram to explain patterns used in pattern matching by the code extracting unit.

### DETAILED DESCRIPTION

An image processing apparatus according to one embodiment of the present invention includes an attribute acquiring unit that acquires an attribute signal that indicates an attribute of image data; a correcting unit that corrects the attribute signal to obtain a plurality of attribute signals each of which indicates an attribute different from the attribute indicated by the attribute signal; and an image processing unit that performs a plurality of image processings on the image data based on each of the attribute signals obtained.

An image processing apparatus according to another embodiment of the present invention includes a compressor that irreversibly compresses image data; a storage unit that stores the compressed image data; an expander that expands the compressed image data that is stored in the storage unit; an attribute acquiring unit that acquires an attribute signal that indicates an attribute of the image data before being irreversibly compressed by the compressor; a holding unit that holds the attribute signal acquired by the attribute acquiring unit; a correcting unit that corrects the attribute signal held by the holding unit to obtain a plurality of attribute signals each of which indicates an attribute different from the attribute indicated by the signal; and an image processing unit that performs a plurality of image processings on the image data expanded by the expander based on each of the attribute signals corrected by the correcting unit.

An image processing method according to still another embodiment of the present invention includes acquiring an attribute signal that indicates an attribute of image data; correcting the attribute signal to obtain a plurality of attribute signals each of which indicates an attribute different from the attribute indicated by the attribute signal; and performing a plurality of image processings on the image data based on each of the attribute signals obtained.

An image processing method according to still another embodiment of the present invention includes acquiring an attribute signal indicating an attribute of image data before being irreversibly compressed; irreversibly compressing the image data; storing the irreversibly compressed image data; holding the attribute signal acquired in the acquiring; expanding the stored irreversibly compressed image data; correcting the attribute signal held in the holding to obtain a plurality of attribute signals each of which indicates an attribute different from the attribute indicated by the signal; and performing a plurality of image processings on the image data expanded in the expanding based on each of the attribute signals obtained in the correcting.

A computer program according to still another embodiment of the present invention realizes the methods according to the present invention on a computer.

The other objects, features, and advantages of the present invention are specifically set forth in or will become apparent from the following detailed description of the invention when read in conjunction with the accompanying drawings.

Exemplary embodiments of an image processing apparatus, an image processing method, and a program according to the present invention will be explained below in detail with reference to the accompanying drawings.

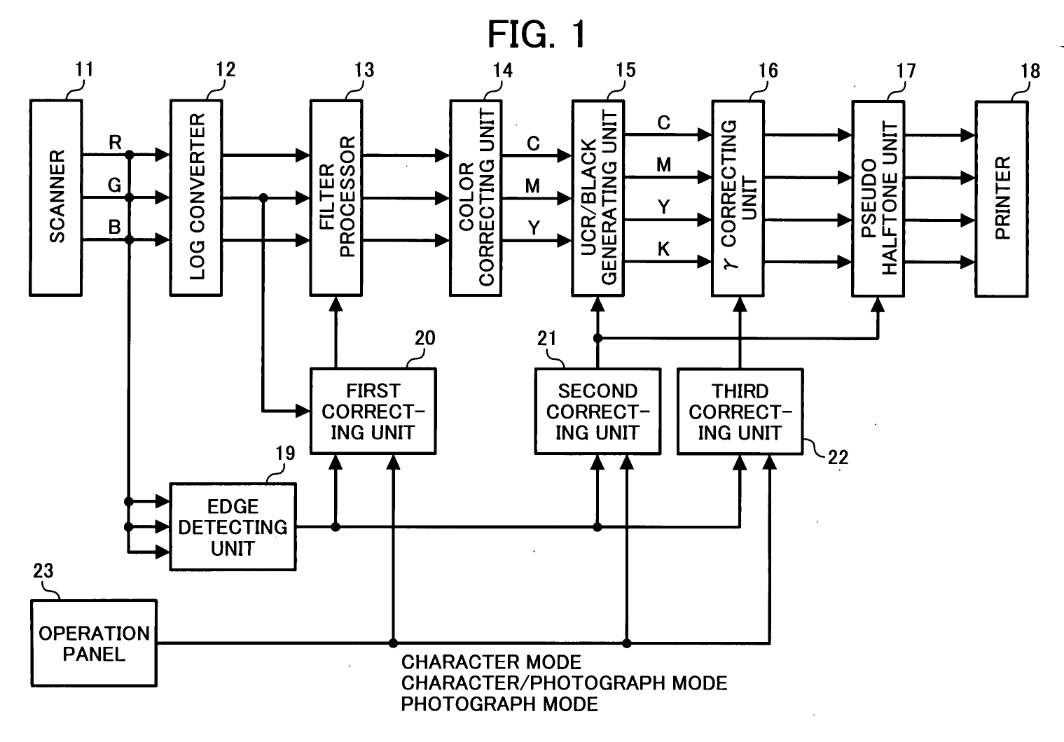

FIG. 1 is a block diagram of the image processing apparatus that employs the image processing method according to one embodiment of the present invention. The image processing apparatus 1 includes a scanner 11, a LOG converter 12, a filter processor 13, a color correcting unit 14, an UCR (Under Color Removal)/black generation unit 15, a γ-correcting unit 16, a pseudo halftone unit 17, a printer 18, an edge detecting unit 19, a first correcting unit 20, a second correcting unit 21, a third correcting unit 22, and an operation panel 23.

The operation panel 23 is directed for user's inputting various instructions into the image processing apparatus 100, which outputs an instruction signal in response to user's operation contents. In the image processing apparatus 100 according to the present embodiment, the user can appropriately scan the operation panel (mode setting unit) 23 to set and instruct an image processing mode.

The user can select and set any one image processing mode from among the three image processing modes such as a character mode, a character/photograph mode, and a photograph mode. The character mode is a mode in which the image processing apparatus 100 operates such that a suitable image processing is performed on a character image, the character/photograph mode is a mode in which the image processing apparatus 100 operates such that a suitable image processing is performed on an image where characters and photographs coexist, and the photograph mode is a mode in which the image processing apparatus 100 operates such that a suitable image processing is performed on a photograph image. The image processing mode is not limited to the three modes, and may employ modes that can operate the image processing apparatus 100 such that a suitable image processing is performed according to contents of an image to be processed, which is other than the above.

The scanner 11 optically reads an original placed on a predetermined position or an original carried by an automatic original carrying device or the like, and generates image data corresponding to the read original. The scanner 11 is a color scanner and generates RGB signals corresponding to the read image, but may be naturally a monochrome scanner.

The scanner 11 is incorporated in the image processing apparatus 100, and can perform a processing for the image data generated by the scanner 11. But in an image processing apparatus that does not incorporate the scanner 11, there may be provided an input interface that fetches image data generated by an outside scanner or the like via a cable or communication unit such as short-distance radio communication.

The scanner 11 outputs the image data generated by reading the original in the above manner to the LOG converter 12 and the edge detecting unit 19.

The LOG converter 12 performs LOG conversion on the RGB image data supplied from the scanner 11 and converts the image data that is liner to a reflectivity into image data that is liner to a density. The LOG converter 12 outputs the image data after being converted to the filter processor 13 and the first correcting unit 20.

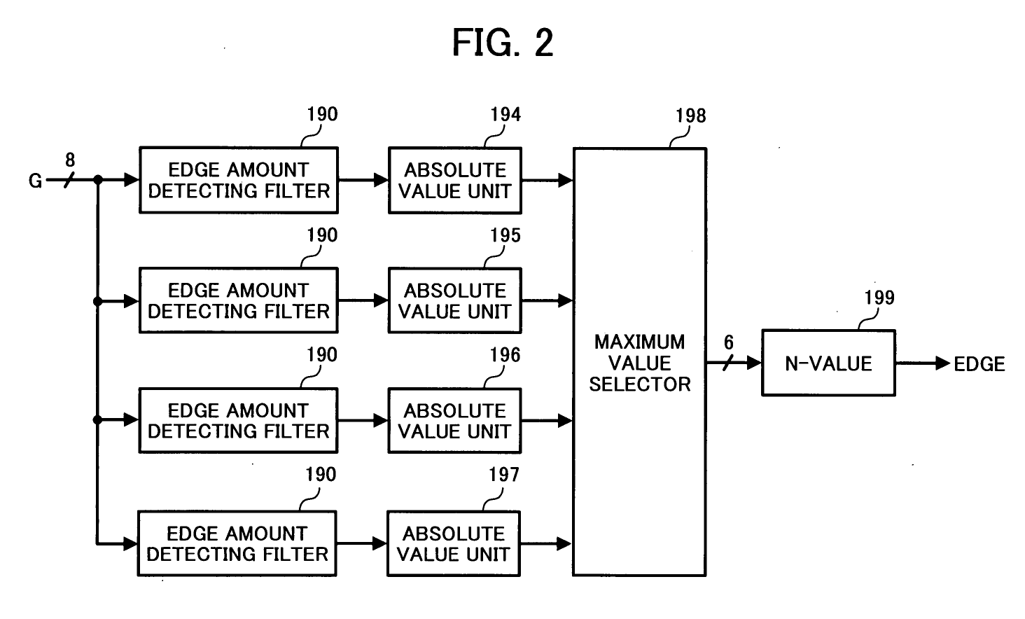

The edge detecting unit 19 detects an edge in the image corresponding to the image data from the image data to be processed, which is supplied from the scanner 11. As shown in FIG. 2, the edge detecting unit 19 according to the present embodiment includes an edge detection filter 190, an edge detection filter 191, an edge detection filter 192, an edge detection filter 193, absolute value units 194, 195, 196, and 197 provided in correspondence to each of the four edge detection filters, a maximum value selector 198, and an N-value unit 199.

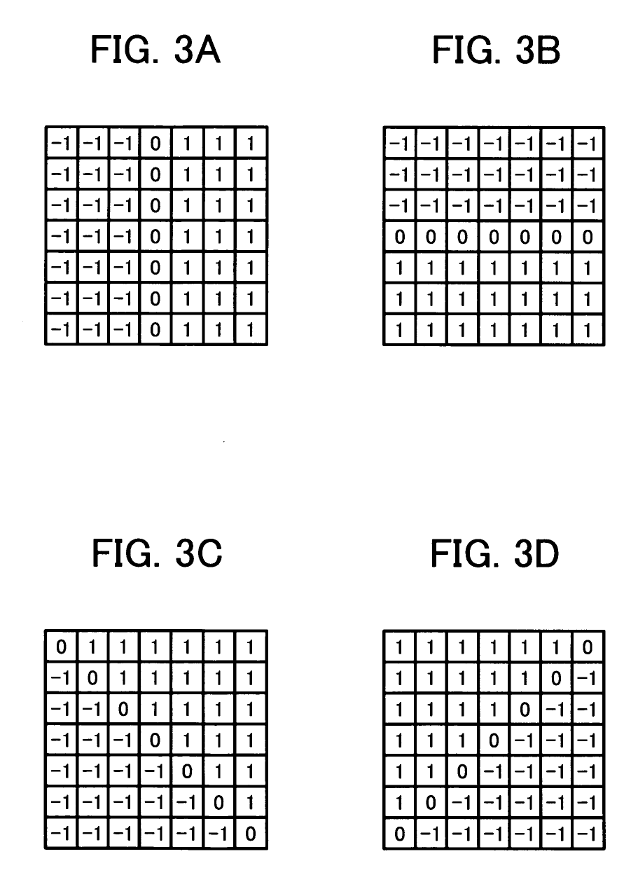

The image data (G) supplied from the scanner 11 is supplied to the respective edge detection filters 190 to 193. Each of the edge detection filters 190 to 193 may employ a 7×7 filter (a) to (d) exemplified in FIG. 3, and performs masking by each filter.

Output values from the four edge detection filters 190 to 193 are supplied to the absolute value units 194 to 197, respectively. Each absolute value unit 194 to 197 outputs an absolute value of the output value of the corresponding edge detection filter to the maximum value selector 198.

The maximum value selector 198 selects the maximum value out of the four absolute values supplied from the four absolute value units 194 to 197, and outputs a 6-bit signal indicating the selected maximum value. In this case, when the maximum value to be output is not less than 64 that is six root of 2, it is rounded to 63 to be output. The N-value unit 199 N-values the output value of the maximum value selector 198, in the present embodiment, binarizes and outputs the same.

The 6-bit signal is output because consistencies with subsequent processings are required, and a signal other than the 6-bit signal may be employed. But in the present embodiment, the rounding is performed to restrict the number of bits of the signal indicating the edge detection amount, thereby reducing processing load and the like.

In the structure shown in FIG. 2, only the G signal among the RGB signals is supplied to each edge detection filter 190 to 194, but limitation is not placed thereon. For example, a combination signal of average values of the RGB signals may be supplied.

The output value detected by the edge detecting unit 19 having the above structure, that is, an attribute signal indicating an attribute that is the edge amount of the image data is output to the first correcting unit 20. The first correcting unit 20 corrects an edge detection result that is the attribute signal of the image data supplied from the edge detecting unit 19 into an attribute signal to be used for deciding the contents of the filter processing by the filter processor 13, that is, an attribute signal indicating an attribute different from the edge detection result, and supplies the same to the filter processor 13.

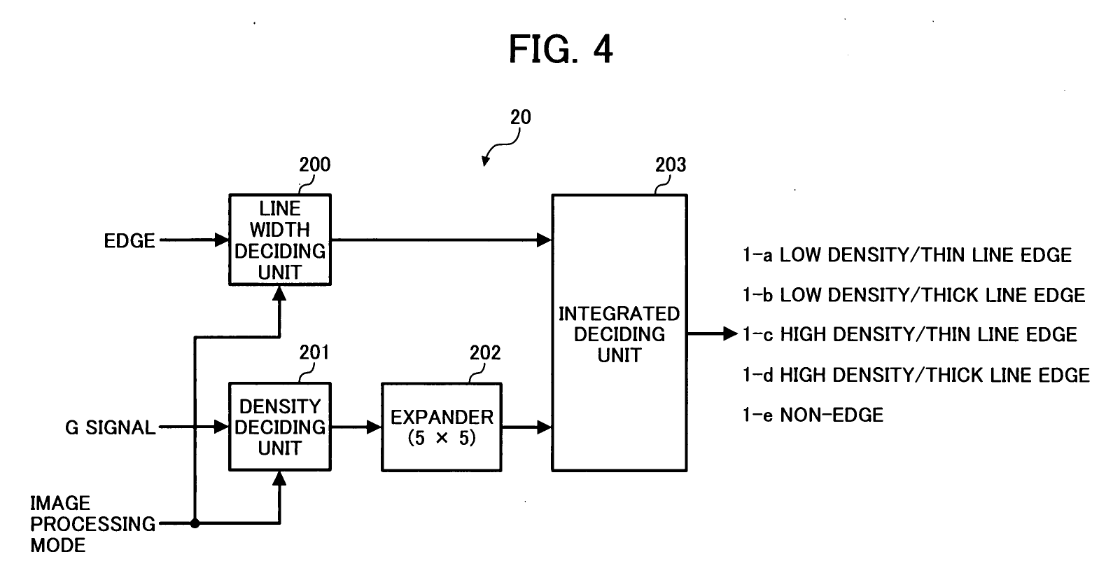

As shown in FIG. 4, the first correcting unit 20 includes a line width deciding unit 200, a density deciding unit 201, an expander 202, and an overall deciding unit 203. As described above, the edge detection result supplied from the edge detecting unit 19 is supplied to the line width deciding unit 200. The currently set image processing mode information is supplied from the operation panel 23 to the line width deciding unit 200.

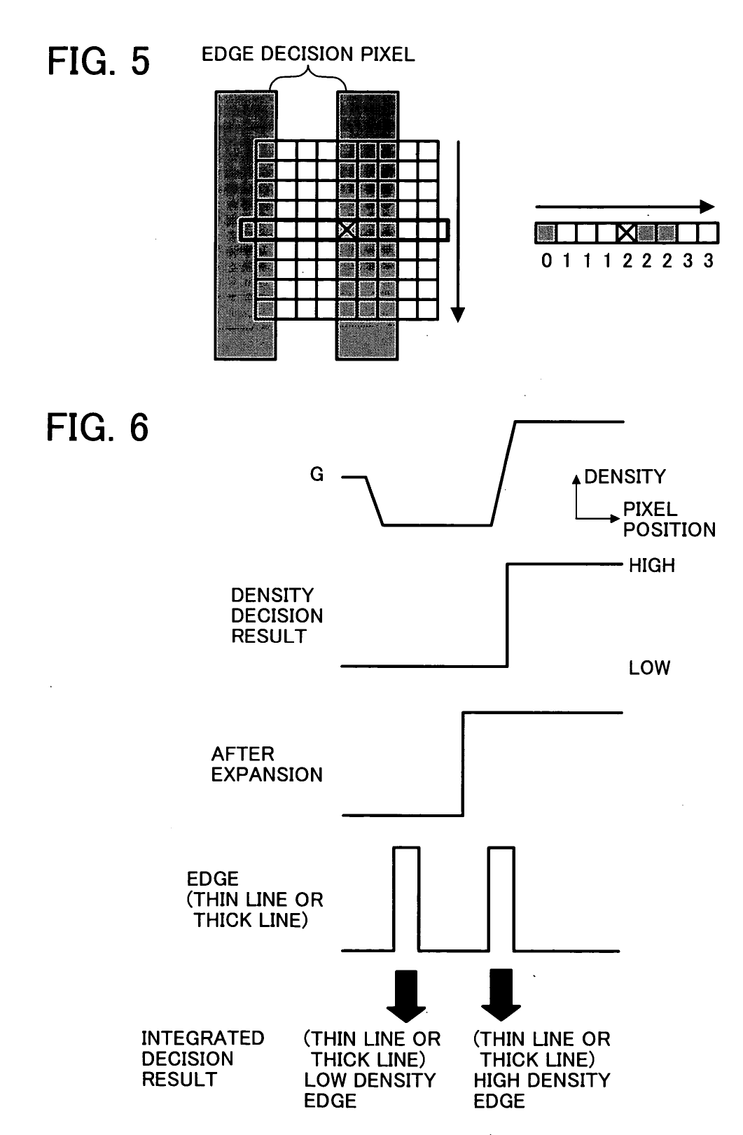

The line width deciding unit 200 decides a line width of an edge with reference to a distance between edges and the like from the edge detection result supplied from the edge detecting unit 19. In the present embodiment, a two-stage decision that the line width is thin or thick is performed. The contents of the line width decision by the line width deciding unit 200 according to the present embodiment will be explained with reference to FIG. 5. As illustrated, the line width deciding unit 200 makes a decision with reference to the edge detection result of 9×9 pixels. More specifically, 9×1 pixels, which are a horizontal line in the drawing among the 9×9 pixels, are sequentially fetched from the left side in the drawing to the right side and referred to, and a counter is incremented by 1 when edge changes to non-edge or non-edge changes to edge. In other words, the number of times when edge changes to non-edge or non-edge changes to edge (both refer to the number of times of edge/non-edge change) is counted in the case where the horizontal lines of the 9×9 pixels are taken by each one line.

The line width deciding unit 200 performs the counting on all the nine horizontal lines. When there is one line where the number of counted times of edge/non-edge change is not less than a predetermined value (i.e., 3), the pixels of interest are decided to be a thin line edge. The similar processing is performed on the vertical lines so that a decision as to whether the line is thin or thick is made. The reference pixel range is made wider or narrower than the 9×9 pixels so that the reference that discriminates a thin line from a thick line can be changed. The reference that discriminates a thin line from a thick line is changed based on the image processing mode supplied from the operation panel 23, and its change contents will be explained later. The line width may be decided in the two stages in this manner, and may be decided in three or more stages.

The image data (G) converted by the LOG converter 12 is supplied to the density deciding unit 201. The density deciding unit 201 decides a density with reference to the image data (G), and outputs a density decision result to the expander 202. A density of each pixel is compared with a predetermined threshold in the density decision according to the present embodiment When the density is more than the threshold, it is decided to be high density “1,” and when the density is less than the threshold, it is decided to be low density “0.” The threshold is changed based on the image processing mode supplied from the operation panel 23, and its change contents will be explained later. The density may be decided in the two stages in this manner, and may be decided in three or more stages.

The expander 202 refers to an active decision result, and when there is one high density “1” in an area of 5×5 image, data on a pixel of interest is decides to be “1.” The overall deciding unit 203 decides an attribute of an image to be processed based on the decision result supplied from the line width deciding unit 200 and the density decision result supplied via the expander 202. In the present embodiment, a decision is made as to which attribute of (1-a) low density/thin line edge, (1-b) low density/thick line edge, (1-c) high density/thin line edge, (1-d) high density/thick line edge, and (1-e) non-edge the image to be processed has, and the result is output as an attribute signal.

(1-a) low density/thin line edge indicates that the image to be processed has a low density and is a thin line edge, and (1-b) low density/thick line edge indicates that the image to be processed has a low density and is a thick line edge. (1-c) high density/thin line edge indicates that the image to be processed has a high density and is a thin line edge, and (1-d) high density/thick line edge indicates that the image to be processed has a high density and is a thick line edge. When an edge is not detected in the image to be processed by the edge detecting unit 19, it is decided to be (1-e) non-edge.

A process up to generating the attribute signal from the edge detection result by the first correcting unit 20 having the above structure will be explained with reference to FIG. 6. As illustrated, when the image data (G) which is liner to the density supplied from the LOG converter 12 is supplied (uppermost stage in the drawing), the density decision (two stages) is made by the density deciding unit 201 (second from the top in the drawing). The density deciding unit 201 compares the density with the predetermined threshold to decide whether the density is low or high, which leads to a result that the density changes at a position near the intermediate of an unsharpened edge.

An expansion processing by the expander 202 is performed on the decision result so that a certain portion of the unsharpened edge is also decided to be high density (third from the top in the drawing). A decision is made as to whether a position (fourth from the top in the drawing) of the edge is in a high density area or in a low density area, and the decision result as to whether the edge is thin or thick, which has been decided by the line width deciding unit 200, is referred to, so that the overall deciding unit 203 can decide which attribute of (1-a) to (1-e) the position has.

The above is the structure of the first correcting unit 20 and the contents of the correction processing by the first correcting unit 20, and the first correcting unit 20 corrects the edge detection result that is an attribute, which the edge detecting unit 19 has acquired from the image data, into a signal indicating an attribute (thick line, thin line, density) different therefrom, and outputs the attribute signal after being corrected to the filter processor 13.

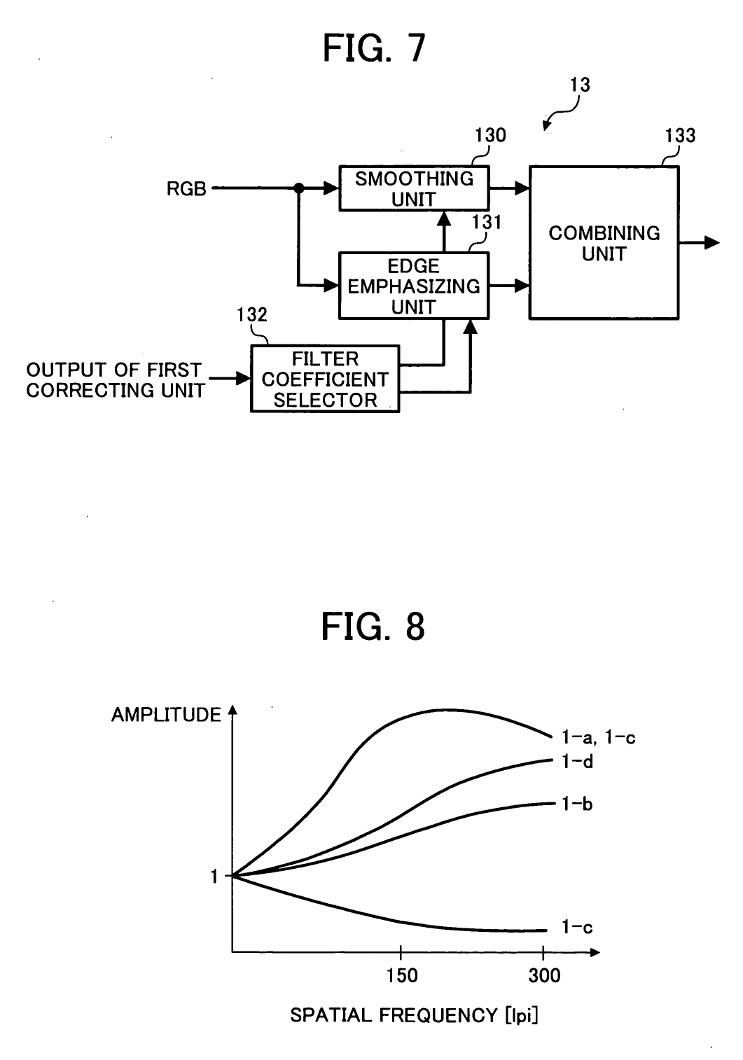

The filter processor 13 shown in FIG. 1 performs filter processing on the image data (RGB) supplied from the LOG converter 12 based on the attribute signal supplied from the first correcting unit 20. More specifically, the filter processor 13 performs filter processing to limit undulations in dots and restrict moire while increasing sharpness of a character portion, and its structure will be shown in FIG. 7.

As illustrated, the filter processor 13 includes a smoothing unit 130, an edge emphasizing unit 131, a filter coefficient selector 132, and a combining unit 133. The image data from the LOG converter 12 is supplied to the smoothing unit 130 and the edge emphasizing unit 131, and a smoothing processing and an edge emphasis processing are performed on the image data, respectively. The image data after the smoothing processing by the smoothing unit 130 and the image data after the edge emphasis processing by the edge emphasizing unit 131 are combined in the combining unit 133. The combining unit 133 combines these items of image data at a predetermined ratio, for example, at a ratio of 1:1 and outputs the same. In other words, the filter processor 13 according to the present embodiment functions as one combination filter of a filter that performs the smoothing processing and a filter that performs the edge emphasis processing.

The filter coefficient selector 132 selects a filter coefficient to be set in each unit of the filter processor 13 based on the attribute signal supplied from the first correcting unit 20. In the present embodiment, when (1-a) to (1-e) is supplied as the attribute signal, a filter coefficient is selected such that the filter processor 13 that functions as the combination filter of the smoothing processing and the edge emphasis processing has the characteristics as shown in FIG. 8.

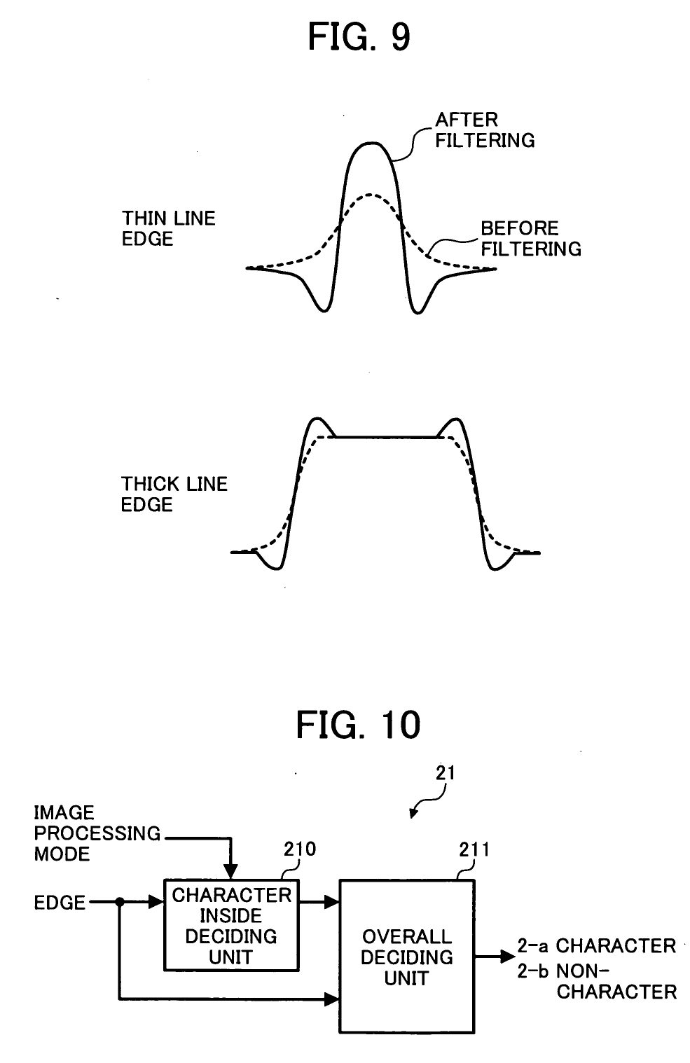

As illustrated, when the attribute of the image is (1-a) low density/thin line edge or (1-c) high density/thin line edge, a filter coefficient is selected such that a filter processing that emphasizes both a low frequency component and a high frequency component of the image data is realized by the filter processor 13. The low frequency component is also emphasized because a processing that entirely raises the degree of emphasis is required as shown in the upper stage of FIG. 9 in the thin line edge in order to improve the quality of the image. A solid line in FIG. 9 indicates the image data after the filter processing, and a dashed line indicates the image corresponding to the image data before the filter processing.

When the attribute of the image is (1-b) low density/thick line edge or (1-d) high density/thick line edge, a filter coefficient is selected such that a filter processing that emphasizes only the high frequency component of the image data is realized by the filter processor 13. Only the high frequency component is emphasized in the thick line edge in this manner because the quality of the image can be improved only by correcting the sharpness as shown in the lower stage of FIG. 9.

As shown in FIG. 8, the shape of the filter characteristics is substantially identical in (1-b) and (1-c) (the characteristics are similar), but the amplitude is made different. While a stronger emphasis processing should be performed with the emphasis on legibility in (1-b) low density/thick line edge, there is a fear that when the degree of emphasis is remarkably increased in (1-d) high density/thick line edge, a defect occurs where a difference of densities between the edge and the area other than the character inside the edge is remarkably increased so that the character looks edged. Therefore, even in the filter processing for the thick line edge image as described above, the processing contents are made different such as the amplitude is made different depending on the density, so that a suitable image processing is performed according on the density or line width.

In the present embodiment, although the filter processing having the same contents is performed in (1-a) low density/thin line edge and in (1-c) high density/thin line edge (see FIG. 8), the filter processing having a larger amplitude may be performed especially in order to improve the legibility in (1-a) low density/thin line edge as compared with in (1-c) high density/thin line edge.

Since in the filter processor 13, the contents of the filter processing on the image data are made different based on the attribute signal supplied from the first correcting unit 20, the contents of the filter processing change depending on which attribute signal the first correcting unit 20 generates and outputs to the filter processor 13. The first correcting unit 20 changes the generation reference of the attribute signal based on the currently set image processing mode supplied from the operation panel 23, so that a suitable filter processing can be performed by the filter processor 13 according to the set image processing mode.

More specifically, the first correcting unit 20 makes the reference of the line width decision or density decision different according to the image processing mode as follows so that a suitable image processing can be performed in the filter processor 13 according to the set image processing mode.

When the character mode is set as the image processing mode, the image processing that improves sharpness and legibility in the entire character image is suitable for improvement in the quality of the image. Therefore, the first correcting unit 20 uses the decision reference by which the decision result by the line width deciding unit 200 shown in FIG. 4 easily indicates a thin line edge when the character mode is set. Thus, in many cases, an edge that would be decided to be thick in other modes is decided to be thin when the character mode is set, and a processing suitable for the thin line edge, that is, suitable for improvement in the sharpness or legibility of the character is performed by the filter processor 13 in this case.

The line width decision reference is set such that the result easily indicates a thick line in the photograph mode as compared with in the character mode, and an intermediate decision reference may be used in the character/photograph mode.

The filter characteristics (amplitude) are made different for improvement in the legibility of the low density/thin line edge between in (1-a) low density/thin line edge and in (1-c) high density/thin line edge. Specifically, when the amplitude is increased in (1-a), the decision reference by the density deciding unit 201 may be different according to the image processing mode. More specifically, the density is easily decided to be low in the character mode as compared with in the other modes, so that the filter processing having the large amplitude is easily performed on more images, thereby improving the legibility of the character.

Returning to FIG. 1, the image data on which the filter processor 13 has performed the filter processing as described above is supplied to the color correcting unit 14. The color correcting unit 14 converts R′G′B′ signals supplied from the filter processor 13 into C′M′Y′ signals corresponding to toner colors of the printer at the rear stage. More specifically, the color correcting unit 14 acquires the C′M′Y′ signals from the R′G′B′ signals according to the following equations.
C′=a0+a1×R′+a2×G′+a3×B′
M′=b0+b1×R′+b2×G′+b3×B′
Y′=c0+c1×R′+c2×G′+c3×B′

In the equations, a0 to a3, b0 to b3, and c0 to c3 are color correction parameters, and achromatic color is ensured such that C′=M′=Y′ is satisfied in the case of R′=G′=B′.

The image data (C′M′Y′) color-corrected by the color correcting unit 14 and the attribute signal of the image from the second correcting unit 21 are supplied to the UCR/black generation unit 15, and an image processing based on the attribute signal is performed in the UCR/black generation unit 15.

The second correcting unit 21 corrects the edge detection result supplied from the edge detecting unit 19 into an attribute signal to be used for deciding the contents of the processing by the UCR/black generation unit 15, that is, an attribute signal indicating an attribute different from the edge detection result, and outputs the same to the UCR/black generation unit 15.

As shown in FIG. 10, the second correcting unit 21 includes a character inside deciding unit 210 and an overall deciding unit 211. The character inside deciding unit 210 decides whether or not an image to be processed is the character inside area based on the edge detection result supplied from the edge detecting unit 19 and the currently set image processing mode supplied from the operation panel 23.

The character inside area means an area that is defined as a pattern area inside the character area in an image, and the character inside deciding unit 210 decides whether or not the image is the character inside area

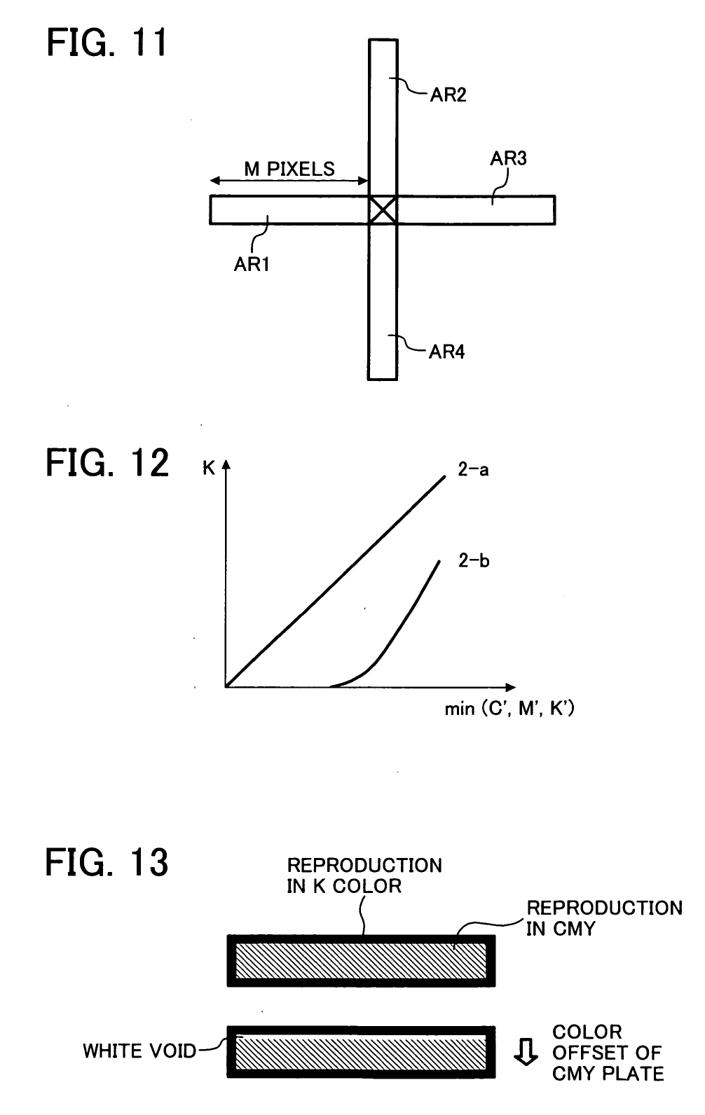

The decision processing contents as to whether or not the image is the character inside area by the character inside deciding unit 210 will be explained with reference to FIG. 11. As illustrated, the character inside deciding unit 210 makes a decision with reference to M pixels (here, M=17) that are previously determined in the vertical and horizontal directions of the pixel of interest. In the following explanation, the areas for the M pixels in the vertical and horizontal directions are referred to as AR1, AR2, AR3, and AR4.

The character inside deciding unit 210 decides whether or not the pixel of interest is an area surrounded by the character area, that is, an area surrounded by the edge area as follows. In other words, the decision is made depending on whether the pixel that is the edge area is present in both the vertical areas AR2 and AR4 or in both the horizontal areas AR1 and AR3. That is, when the edge area (edge pixel) is present in both the vertical areas or in both the horizontal areas, the pixel of interest is decided to be the area surrounded by the character area, and when the edge pixel is present in neither area or in either area, the pixel is decided not to be the area surrounded by the character area When the edge pixel is present in the three areas or more among the four areas AR1 to AR4, the pixel is determined to be the area surrounded by the character area, and when the pixel is present in the two areas or less, the pixel is determined not to be the area surrounded by the character area

When the pixel of interest is the area surrounded by the character area in the decision, the character inside deciding unit 210 decides whether or not the pixel of interest is non-edge, and when the pixel is non-edge, the unit 210 decides that the pixel is the character inside area In other words, as described above, since the character inside area is the area surrounded by the character area and a pattern portion other than the character, the area that is surrounded by the character area and is non-edge can be determined to be the character inside area. On the other hand, when the pixel is not the area surrounded by the character area, even the area surrounded by the character area is determined not to be the character inside area when the pixel of interest is an edge.

The decision reference as to up to which thickness the character is decided to be the character inside area can be changed by increasing or decreasing the reference pixel range (the value of M) in the vertical and horizontal directions than 17. The decision reference is changed based on the image processing mode supplied from the operation panel 23, and its change contents will be explained later.

The character inside deciding unit 210 decides whether or not the pixel is the character inside area as described above, but may decide depending on the degree of the character inside area in three or more stages. Specifically, several reference sizes in the vertical and horizontal directions of the pixel of interest are prepared (for example, two kinds of M=17 and M=27), a decision as to whether or not the pixel is the character inside area is made at the respective sizes. The decision may be made such as the pixel that is the character inside area in both M=17 and M=27 (the degree of the character inside area is large), the pixel that is the character inside area only in M=27 (the degree of the character inside area is small), and the pixel that is not the character inside area in neither M=17 nor M=27 (not the character inside area).

The character inside deciding unit 210 outputs the decision result, that is, the decision result as to whether or not the pixel is the character inside area to the overall deciding unit 211. On the other hand, the edge detection result from the edge detecting unit 19 has been supplied to the overall deciding unit 211. The overall deciding unit 211 decides an attribute of the image to be processed based on the detection result from the edge detecting unit 19 and the decision result from the character inside deciding unit 210. In the present embodiment, a decision is made as to which attribute of (2-a) character area and (2-b) non-character area the image to be processed has, and the result is output as an attribute signal.

The overall deciding unit 211 decides that the image to be processed is (2-a) character area when the image is an edge or the decision result of the character inside deciding unit 210 indicates the character inside area, and decides that the image is (2-b) non-character area in other cases. When the degree of the character inside area is decided in the three or more stages as described above, the large degree of the character inside area is contained in (2-a), but the small degree of the character inside area may be added to the two kinds of attribute signals to generate an attribute signal indicating (2-c) the small degree of the character inside area.

The above is the structure of the second correcting unit 21 and the contents of the correction processing by the second correcting unit 21, and the second correcting unit 21 corrects the edge detection result that is an attribute, which the edge detecting unit 19 has acquired from the image data, into a signal indicating an attribute different from the edge detection result (whether or not the image is the character area), and outputs the attribute signal after being corrected to the UCR/black generation unit 15 and the pseudo halftone unit 17.

The UCR/black generation unit 15 as shown in FIG. 1 includes a LUT (Look Up Table) as shown in FIG. 12. The UCR/black generation unit 15 refers to the LUT, and performs black generation processing by a procedure of obtaining “K” corresponding to a minimum value Min (C′M′Y′) of the C′M′Y′ signals supplied from the color correcting unit 14 from the minimum value.

As shown in FIG. 12, in the present embodiment, a table to be used when the attribute signal supplied from the second correcting unit 21 is (2-a) character area and a table to be used when the signal is (2-b) non-character area are prepared, and the UCR/black generation unit 15 selects the table to be utilized based on the attribute signal supplied from the second correcting unit 21.

Therefore, when the supplied attribute signal is (2-a) character area, 100% black generation is performed, and when the signal is (2-b) non-character area, black generation to reproduce a highlight in CMY is performed. In other words, since there is a fear that k dots stand out and lead to granulation when the black generation is performed on the highlight, the black generation is performed on the image that is the non-character area in order to restrict the granulation. On the other hand, the 100% black generation is performed on the character area in order to reproduce a visually sharp black character by eliminating coloring of the black character, and to enable better black character reproduction without coloring even when the CMYK plate is offset in outputting by the printer.

In the present embodiment, since the character inside area is also decided to be (2-a) character area, the 100% black generation is performed on the character inside area. The 100% black generation is performed on the character inside area because of the following reasons. In other words, when the rate of black generation is increased only on the character edge of the black character, although the character edge is reproduced in “K” color (i.e., black) as shown in FIG. 13, the character inside area is reproduced in CMY The reproduction is performed especially in reproducing a black thick character having a low density. When the edge is reproduced in “K” color and the inside is reproduced in CMY, there is a fear that a defect such as white void occurs as shown in the lower stage of FIG. 13 when the CMY plate is offset. The processing having a high rate of the black generation is also performed on the character inside area in order to restrict occurrence of the defect.

The UCR/black generation unit 15 performs the black generation processing according to the attribute signal, and performs under color removal (UCR) that reduces the amount according to the “K” signal generated from the C′M′Y′ signals. The under color removal is performed according to the following equations:
C=C′−K
M=M′−K
Y=Y′−K.

As described above, since the contents of the black generation processing on the image data is made different in the UCR/black generation unit 15 based on the attribute signal supplied from the second correcting unit 21, the contents of the black generation processing changes depending on which attribute signal the second correcting unit 21 generates and outputs to the UCR/black generation unit 15. The second correcting unit 21 changes the generation reference of the attribute signal based on the currently set image processing mode supplied from the operation panel 23 so that a suitable black generation processing is performed by the UCR/black generation unit 15 according to the set image processing mode.

More specifically, the second correcting unit 21 makes the decision reference as to whether or not the image is the character inside area different according to the image processing mode, so that a suitable black generation processing is performed in the UCR/black generation unit 15 according to the set image processing mode.

When the character mode is set as the image processing mode, a decision is made as to whether or not the image is the character inside area, so that white void and the like caused by the CMY plate's offset can be prevented. On the other hand, since defect prevention is emphasized in the photograph mode or character/photograph mode, a decision as to whether or not the image is the character inside area is not made. Thus, a decision as to whether the image is the character area or the non-character area is made by the edge detection result from the edge detecting unit 19.

Returning to FIG. 1, the image data (CMYK) output from the UCR/black generation unit 15 is supplied to the γ-correcting unit 16. The attribute signal of the image has been supplied to the γ-correcting unit 16 from the third correcting unit 22, and γ-correction processing based on the attribute signal is performed in the γ-correcting unit 16.

The third correcting unit 22 corrects the edge detection result supplied from the edge detecting unit 19 into an attribute signal to be used in deciding the contents of the processing by the γ-correcting unit 16, that is, an attribute signal indicating an attribute different from the edge detection result, and supplies the same to the γ-correcting unit 16.

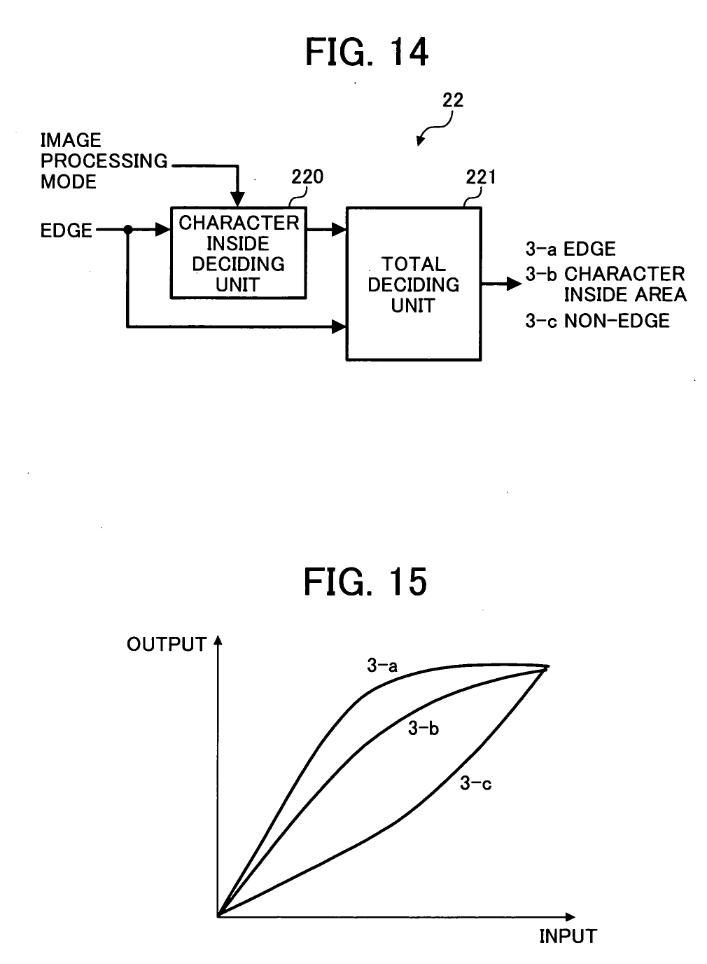

As shown in FIG. 14, the third correcting unit 22 includes a character inside deciding unit 220 and an overall deciding unit 221. The character inside deciding unit 220 decides whether or not the image to be processed is the character inside area based on the edge detection result supplied from the edge detecting unit 19 and the currently set image processing mode supplied from the operation panel 23.

The contents of the decision processing by the character inside deciding unit 220 are similar to those of the character inside deciding unit 210 in the second correcting unit 21, but the reference pixel size (see FIG. 11) is made larger in the character inside deciding unit 220 in the third correcting unit 22 (M=27). The reason for this is as follows. In other words, since a boundary defect between a black-character processing and a non-character processing easily stands out, it is not preferable that the processing is changed by the remarkably large area On the other hand, since the defect does not easily stand out even when the processing is changed by the relatively large area in the γ-correction depending on the setting of the correction table, a character larger than that in the UCR/black generation processing can be handled. Naturally, the reference size may be the same as that of the character inside deciding unit 210 in the second correcting unit.

The character inside deciding unit 220 decides, similarly to the character inside deciding unit 210 in the second correcting unit 21, whether or not the image to be processed is the character inside area, and outputs the decision result to the overall deciding unit 221. On the other hand, the edge detection result from the edge detecting unit 19 has been supplied to the overall deciding unit 221. The overall deciding unit 221 decides the attribute of the image to be processed based on the detection result from the edge detecting unit 19 and the decision result from the character inside deciding unit 220. In the present embodiment, a decision is made as to which attribute of (3-a) character area, (3-b) character inside are, and (3-c) non-character area the image to be processed has, and the decision result is output as an attribute signal.

When the image to be processed is an edge, the overall deciding unit 221 decides that the image is (3-a) character area, and when the decision result of the character inside deciding unit 220 indicates the character inside area, the unit 221 decides that the image is (3-b) character inside area, and decides that the image is (3-c) non-character area in other case.

The above is the structure of the third correcting unit 22 and the contents of the correction processing by the third correcting unit 22. The second correcting unit 21 corrects the edge detection result that is an attribute, which the edge detecting unit 19 has acquired from the image data, into a signal indicating an attribute different from the edge detection result (character area, character inside area, non-character area), and outputs the attribute signal after being corrected to the γ-correcting unit 16. The character inside deciding unit 220 in the third correcting unit 22 may be structured as a different circuit from the character inside deciding unit 210 in the second correcting unit 21, but the same circuit may be used to change the parameter setting so that the functions of the character inside deciding unit 220 and the character inside deciding unit 210 can be realized.

The γ-correcting unit 16 shown in FIG. 1 includes a correction table as shown in FIG. 15. The γ-correcting unit 16 refers to the correction table, and performs γ-correction processing on the image data supplied from the UCR/black generation unit 15.

As shown in FIG. 15, in the present embodiment, there are prepared a table to be used when the attribute signal supplied from the third correcting unit 22 is (3-a) character area, a table to be used when the signal is (3-b) character inside area, and a table to be used when the signal is (3-c) non-character area, and the γ-correcting unit 16 selects the table to be utilized based on the attribute signal supplied from the third correcting unit 22.

Therefore, the supplied attribute signal is (3-a) character area, correction is made such that the outputs in the low density and intermediate density areas are increased, and when the signal is (3-b) character inside area, correction is made such that the outputs in the low density and intermediate density areas are further increased. The outputs in the low and intermediate density areas are increased in the character inside area because there is a fear that a difference of densities between the edge and the character inside area occurs in the character inside area as shown in FIG. 9, and the difference requires to be corrected by increasing the density in the character inside area The γ-correction processing that emphasizes the gradation is performed when the signal is (3-c) non-edge area

As described above, since the γ-correcting unit 16 makes the contents of the black generation processing on the image data different based on the attribute signal supplied from the third correcting unit 22, the contents of the γ-correction processing changes depending on which attribute signal the third correcting unit 22 generates and outputs to the γ-correcting unit 16. The third correcting unit 22 changes the generation reference of the attribute signal based on the currently set image processing mode supplied from the operation panel 23 so that a suitable γ-correction processing is performed by the γ-correcting unit 16 according to the set image processing mode.

More specifically, the third correcting unit 22 decides, similarly to the second correcting unit 21, whether or not the image is the character inside area when the character mode is set as the image processing mode, so that white void and the like caused by the CMY plate's offset can be prevented. On the other hand, since the defect prevention is emphasized in the photograph mode or character/photograph mode, a decision is not made as to whether or not the image is the character inside area

Returning to FIG. 1, the image data (CMYK) output from the γ-correcting unit 16 is supplied to the pseudo halftone unit 17. An attribute signal of the image has been supplied to the pseudo halftone unit 17 from the second correcting unit 21, and a pseudo halftone processing based on the attribute signal is performed in the pseudo halftone unit 17.

The pseudo halftone unit 17 performs pseudo halftone processing such as dither or error diffusion on the image data supplied from the γ-correcting unit 16. The pseudo halftone unit 17 performs pseudo halftone processing based on the attribute signal supplied from the second correcting unit 21. More specifically, while the dither processing of 300 lines is performed when the attribute signals is (2-a) character area to realize high resolution reproduction, the dither processing of 200 lines is performed when the signal is (2-b) non-character area to realize high graduation reproduction. Although the character inside area is contained in (2-a) character area, the pseudo halftone processing is made different so that the dither basic tone does not change between the edge and the character inside area and a defect is prevented to occur.

The pseudo halftone unit 17 performs pseudo halftone processing on the image data according to the attribute signal supplied from the second correcting unit 21, and outputs the image data after the processing to the printer 18. The printer 18 outputs an image corresponding to the image data on which the various image processings has been performed, which is supplied from the pseudo halftone unit 17, to a sheet or the like.

As described above, in the present embodiment, a plurality of image processings are performed on the image data input from the scanner 11, such as the filter processing by the filter processor 13, the black generation processing by the UCR/black generation unit 15, the γ-correction processing by the γ-correcting unit 16, and the pseudo halftone processing by the pseudo halftone unit.

The first correcting unit 20, the second correcting unit 21, and the third correcting unit 22 correct the attribute signal (edge detection result) acquired from the image, and generate the different attribute signal, respectively, to be used in each decision of the image processing contents. Therefore, as described above, the first correcting unit 20, the second correcting unit 21, and the third correcting unit 22 can generate the different attribute signals, that is, the attribute signals suitable for deciding the contents of each image processing such as the filter processing, the UCR/black generation, the γ-correction processing, and the pseudo halftone processing, respectively. As a result, a suitable image processing can be performed according to various attributes of the image to be processed so that the image having a higher quality can be obtained.

Since the correction references of the attribute signal by the first correcting unit 20, the second correcting unit 21, and the third correcting unit 22 are made different according to the image processing mode such as the character mode, the character/photograph mode, and the photograph mode, a suitable image processing in conformity with the set image processing mode can be performed by the filter processor 13, the UCR/black generation unit 15, the γ-correcting unit 16, the pseudo halftone unit 17, and the like.

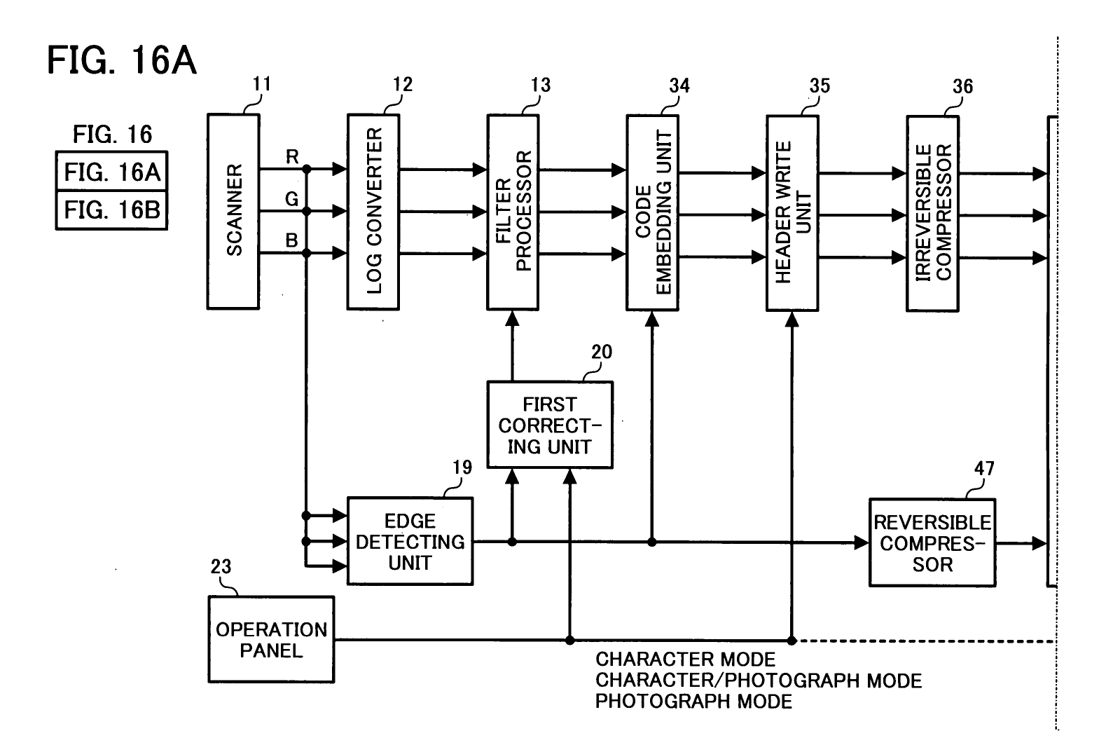

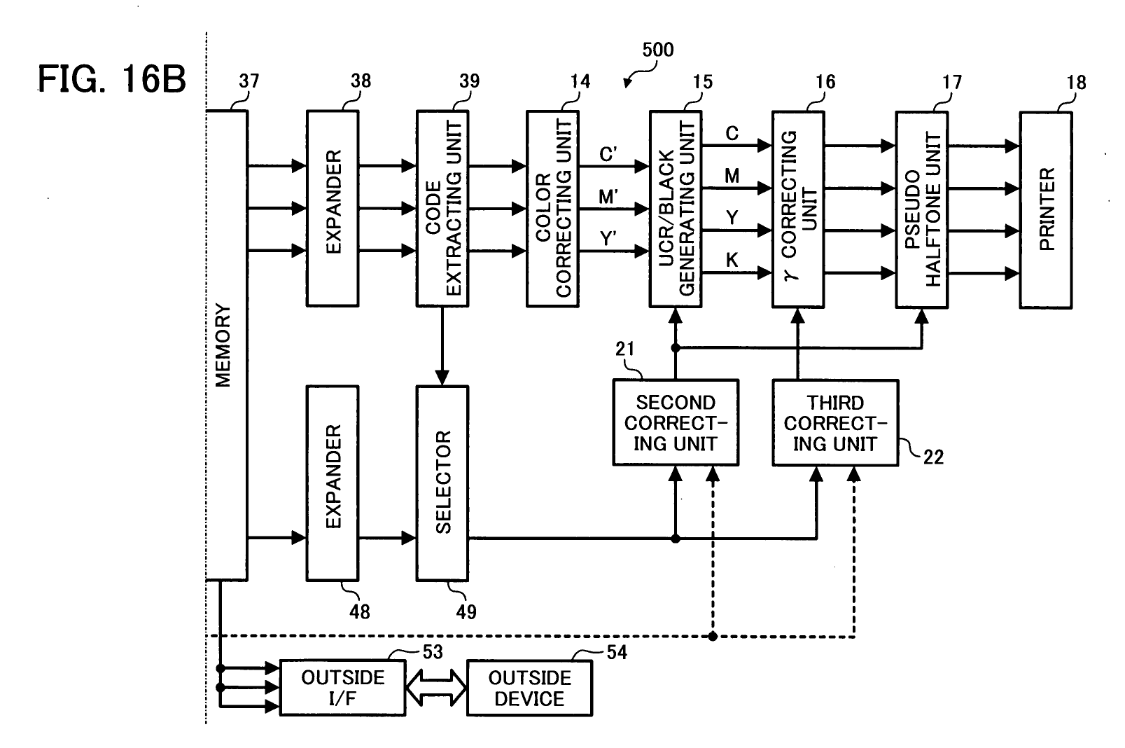

FIG. 16 is a block diagram of an image processing apparatus that employs the image processing method according to one embodiment of the present invention. In this embodiment, like reference numerals are denoted to the components common to those in one embodiment, and a description thereof will be omitted.

An image processing apparatus 500 according to one embodiment is different from a previously-described embodiment in that the image processing apparatus 500 includes a code embedding unit 34, a header write unit 35, an irreversible compressor 36, a memory 37, an expander 38, a code extracting unit 39, a reversible compressor 47, an expander 48, a selector 49, and an outside interface (I/F) 53, and will be mainly explained on the difference.

Image data on which a filter processing according to an attribute signal (line width, density) is performed by the filter processor 13 similarly as in a previously-described embodiment is supplied to the code embedding unit 34 according to another embodiment, and the edge detection result from the edge detecting unit 19 is supplied thereto.

The code embedding unit 34 embeds the edge detection result supplied from the edge detecting unit 19 into the image data supplied from the filter processor 13 as an extractable code. An electronic watermark technique may be used as the method for embedding a code, but other technique for embedding other data into image data may be employed.

The header write unit 35 writes information indicating the image processing mode supplied from the operation panel 23 into a header. When the image processing mode is written as the header information in this manner, the header information is referred to in utilizing the image data to determine in which image processing mode the processing should be performed. The image processing mode information is obtained by referring to the header information in an element (the second correcting unit 21 and the third correcting unit 22) at the rear stage of the header write unit 35, and an information acquisition path is conveniently shown in a dashed line in FIG. 16.

The irreversible compressor 36 performs irreversible compression such as JPEG (Joint Photographic Experts Group) on the image data where the code is embedded into the code embedding unit 34 at a predetermined ratio. The image data compressed by the irreversible compressor 36 in this manner is accumulated in the memory 37.

The memory 37 accumulates the image data compressed by the irreversible compressor 36 therein. The compressed image data accumulated in the memory 37 can be read and supplied to the expander 38 when the compressed image data is utilized (printed by the printer 18, or the like) in the image processing apparatus 500. The image data accumulated in the memory 37 can be read by the outside interface 53 and transmitted to an outside device 54 when a request from the outside device 54 such as a PC (Personal Computer) is made via the outside interface 53, and on the other hand, the memory 37 can receive and accumulate the image data supplied from the outside device 54.

For example, the memory 37 can be accessed via the outside interface 53 (LAN interface or the like) from the PC or the like to read the compressed image data accumulated in the memory 37 and to display the image on a display of the PC for use.

The image processing apparatus 500 according to the present embodiment includes the reversible compressor 47, and the edge detection result from the edge detecting unit 19 is supplied to the reversible compressor 47. The reversible compressor 47 reversibly compresses the edge detection result and accumulates the same in the memory 37. The image data irreversibly compressed by the irreversible compressor 36 and the compressed data of the edge detection result acquired from the image data are corresponded to be accumulated in the memory 37. When the image data is read for use, the compressed data of the acquired edge detection result on the image data can be together read and utilized.

The expander 38 reads the irreversibly compressed image data accumulated in the memory 37 to perform expansion processing, and outputs the image data after being expanded to the code extracting unit 39.

The code extracting unit 39 extracts the code indicating the edge detection result embedded into the expanded image data and outputs the extracted edge detection result to the selector 49, and outputs the expanded image data (RGB signals) to the color correcting unit 14.

The expander 48 reads the reversibly compressed edge detection result accumulated in the memory 37 to perform the expansion processing, and outputs the edge detection result after being expanded to the selector 49.

The selector 49 selects either one of the edge detection results supplied from the code extracting unit 39 and the expander 48, and outputs the selected edge detection result to the second correcting unit 21 and the third correcting unit 22. The selector 49 may select any edge detection result, but may select the predetermined one (for example, the edge detection result supplied from the expander 48) and select the other edge detection result when the one edge detection result has not been supplied.

The following effects can be obtained when the image processing is performed on the image data supplied from the outside device 54. For example, when only the image data into which the edge detection result supplied from the outside device 54 is embedded is supplied to the image processing apparatus 500 and accumulated in the memory 37, the data that is obtained by reversibly compressing the edge detection result is not accumulated in the memory 37. In this case, the edge detection result is not supplied from the expander 48 to the selector 49. In the above manner, even when the reversibly compressed data of the edge detection result is not present, the edge detection result embedded into the image data can be extracted and supplied to the second correcting unit 21 and the third correcting unit 22 at the rear stage.

The second correcting unit 21 and the third correcting unit 22 according to one embodiment correct the edge result (attribute signal) supplied from the selector 49 similarly as in one embodiment to generate another new attribute signal (character area, character inside area, non-character area, or the like), and output the same to the UCR/black generation unit 15, the γ-correcting unit 16, and the pseudo halftone unit 17, respectively. Thus, similarly as in one embodiment, a suitable image processing can be performed according to various attributes (character area, character inside area, non-character area, and the like).

The image processing on the image data can be performed as follows. First, various image processings are performed on the image data read by the scanner 11 in the image processing apparatus 500 and the image data is output from the printer 18 in the image processing apparatus 500.

The image data generated by the scanner 11 is supplied to the filter processor 13 via the LOG converter 12. The edge detection processing by the edge detecting unit 19 is performed on the image data, and the edge detection result is supplied to the first correcting unit 20, the code embedding unit 34, and the reversible compressor 47.

The filter processing according to the attribute signal corrected by the first correcting unit 21 is performed by the filter processor 13, and the edge detection result is embedded by the code embedding unit 34 in the image data after the filter processing as an extractable code. The image data into which the edge detection result is embedded is compressed by the irreversible compressor 36 and accumulated in the memory 37. On the other hand, the edge detection result is reversibly compressed by the reversible compressor 47 and accumulated in the memory 37 in correspondence to the image data.

The irreversibly compressed image data accumulated in the memory 37 is expanded by the expander 38, and the edge detection result that is the embedded code is extracted from the expanded image data by the code extracting unit 39 and supplied to the selector 49. On the other hand, the reversibly compressed edge detection result in correspondence to the irreversibly compressed data is also read from the memory 37 and expanded by the expander 48 to be supplied to the selector 49.

The selector 49 selects the edge detection result from the expander 48, which has less possibility of data missing or the like, and outputs the same to the second correcting unit 21 and the third correcting unit 22. The second correcting unit 21 and the third correcting unit 22 correct the edge detection result to another attribute signal, and outputs the corrected attribute signal to the UCR/black generation unit 15, the γ-correcting unit 16, and the pseudo halftone unit 17, respectively. Thus, similarly as in the previously-described embodiment, a suitable image processing can be performed according to various attributes (character area, character inside area, non-character area, and the like).

The image data (into which the edge detection result has been embedded) generated by the outside device 54 is captured into the image processing apparatus 500 via the outside interface 53, and a suitable image processing can be performed on the captured image data according to the attribute.

When the image processing on the image data is performed in this manner, the image data captured from the outside device 54 is accumulated in the memory 37. The expander 38 reads and expands the image data from the memory 37, and the code extracting unit 39 extracts the embedded edge detection result from the image data after being expanded. The extracted edge detection result is supplied to the selector 49. In this case, since the reversibly compressed edge detection result separate from the image data is not present, the selector 49 supplies the edge detection result supplied from the code extracting unit 39 to the second correcting unit 21 and the third correcting unit 22. Thus, similarly as in the previously-described embodiment, a suitable image processing can be performed according to various attributes (character area, character inside area, non-character area, and the like).

The image data generated by the scanner 11 in the image processing apparatus 500 is transmitted to an outside device having the functions similar to those of the image processing apparatus 500, and a suitable image processing according to the attribute of the image is performed in the outside device.

As utilized in this manner, like when the image processing apparatus 500 alone performs image processing, the image data generated by the scanner 11 is accumulated in the memory 37. Therefore, the edge detection result that is the attribute of the image data is embedded into the irreversibly compressed image data accumulated in the memory 37 as an extractable code. The reversibly compressed edge detection result is accumulated in the memory 37 in correspondence to the irreversibly compressed image data.

When a request of transmitting the image data is issued from the outside device 54, the irreversibly compressed image data accumulated in the memory 37 is read and transmitted to the outside device 54 via the outside interface 53. Thus, the outside device 54 can extract the edge detection result embedded into the image data and correct the edge detection result to another attribute signal for use similarly as in the image processing apparatus 100 according to the previously-described embodiment, so that a suitable image processing can be performed in the outside device 54 according to the attribute of the image data.

When the irreversibly compressed image data is transmitted to the outside device 54, the reversibly compressed edge detection result accumulated in correspondence to the image data may be transmitted together. Thus, in the outside device 54 that has received the image data and the edge detection result, similarly as in the image processing apparatus 100 according to the previously-described embodiment, the edge detection result can be corrected to another attribute signal for use, and a suitable image processing can be performed in the outside device 54 according to the attribute of the image data.

In one embodiment, when the image data is irreversibly compressed to be accumulated in the memory 37, the edge detection result that is one of the attributes of the image data before being irreversibly compressed is acquired and the edge detection result is embedded into the image data. Alternatively, the edge detection result is accumulated in the memory 37 in correspondence to the image data.

Therefore, even when the outside device reads and uses (displays, prints, or the like) the irreversibly compressed data accumulated in the memory 37, the embedded edge detection result or the edge detection stored in the correspondence manner can be acquired by the outside device, and the edge detection result obtained from the image before being compressed can be corrected to various attributes to be used for performing a suitable image processing.

On the other hand, when the irreversibly compressed image data accumulated in the memory 37 is used to perform printing or the like in the image processing apparatus 500, the embedded edge detection result or the edge detection result accumulated in the memory 37 in the correspondence manner can be acquired and corrected to various attribute signals so that a suitable image processing can be performed according to various attributes.

The edge detection result acquired from the image data is accumulated in the memory 37, and the edge detection result is read from the memory 37 later as needed and is corrected to a predetermined attribute signal by each correcting unit to be supplied to each image processor. Therefore, it is not necessary to hold various attribute signals in the memory 37 or the like. In other words, required memory resources are restricted by reducing the attribute signals to be held and appropriate attribute signals are obtained through correction according to various image processings so that a suitable image processing according to various attributes of the image to be processed can be realized.

The present invention is not limited to the two embodiments explained above, and can employ various variants exemplified below.

In each embodiment described above, the edge detecting unit 19 detects the presence of an edge as an attribute from the image data input by the scanner 11 and outputs the same to the first correcting unit 20, the second correcting unit 21, and the third correcting unit 23, but the attribute of the image, which is acquired from the input image data, is not limited to the presence of an edge and may be other attribute. The attribute signal indicating the acquired attribute is supplied to each correcting unit, and each correcting unit may correct the same to an appropriate attribute signal according to the corresponding image processing.

The attribute signal that can be acquired by correction of the correcting units such as the first correcting unit 20 to the third correcting unit 22 is not limited to the signals indicating the attributes in the above embodiments (line width, density, character area, character inside area, and the like), and may be attribute signals indicating other kinds of attribute (color and the like), and an attribute signal indicating an appropriate attribute may be generated according to the image processing to be performed on the image data.

In one embodiment, the edge detection result which is the attribute signal is embedded into the image data before being irreversibly compressed, and then the irreversibly compressed image data is accumulated in the memory 37. The attribute signal may be embedded before being accumulated in the memory 37 in this manner, but the image data into which the attribute signal is not embedded may be accumulated in the memory 37 and the attribute signal may be reversibly compressed or may remain accumulated in the memory 37 as it is. At a timing of transmitting the image data to the outside device 54, the image data and the attribute signal are read from the memory 37 to embed the attribute signal into the image data, and the image data into which the attribute signal is embedded may be transmitted to the outside device 54.

In one embodiment, there is provided the code embedding unit 34 that embeds the edge detection result which is the attribute signal into the image data, and the edge detection result is reversibly compressed and accumulated in the memory 37 as another data separate from the image data so that any one of the edge detection results is selected in the selector 49 to be output to the second correcting unit 21 and the third correcting unit 22. The edge detection result that is the attribute signal may be embedded into the image data and may be held as another data, but only embedding of the attribute signal into the image data may be performed, or the attribute signal may not be embedded into the image data but be separately accumulated in the memory.

In one embodiment, the code embedding unit 34 embeds the edge detection result that is the attribute signal into the image data utilizing the electronic watermark technique and the code extracting unit 39 extracts the embedded edge detection result, but when the edge detecting unit 39 acquires the detection result of a black character edge as the attribute signal, code embedding and extracting can be performed as follows.

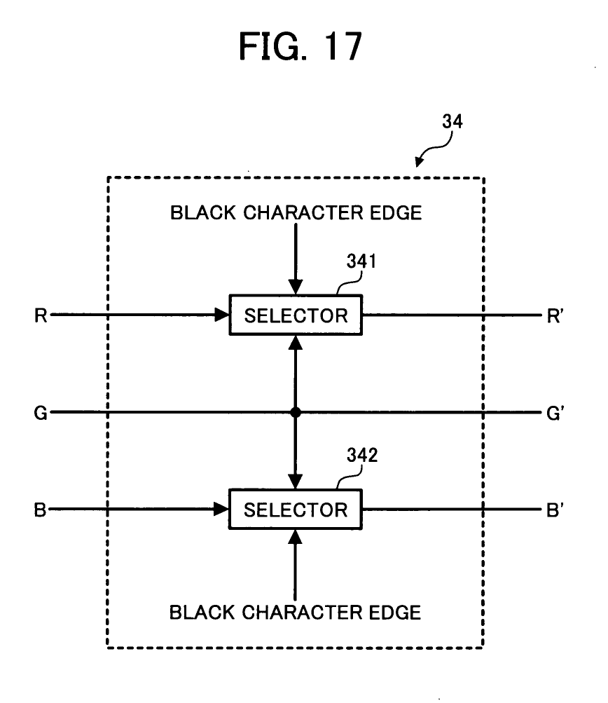

As shown in FIG. 17, the code embedding unit 34 according to the variant includes selectors 341 and 342. The “R” (i.e., red-) signal and the “G” (i.e., green-) signal among the image data (RGB signals) input from the filter processor 13 are input into the selector 341. The selector 341 outputs the “G” signal instead of the “R” signal when the binarized edge detection result supplied from the edge detecting unit 19 is “1,” that is, an edge.

The “B” signal and the “G” signal are input into the selector 342, and the “G” signal is output instead of the “B” signal when the edge detection result input from the edge detecting unit 19 is “1,” that is, an edge. In this manner, the code embedding unit 34 performs a processing of replacing the “R” signal and the “B” signal with the “G” signal by using R=G=B data as a code on the pixel that is decided to be an edge by the edge detecting unit 19.

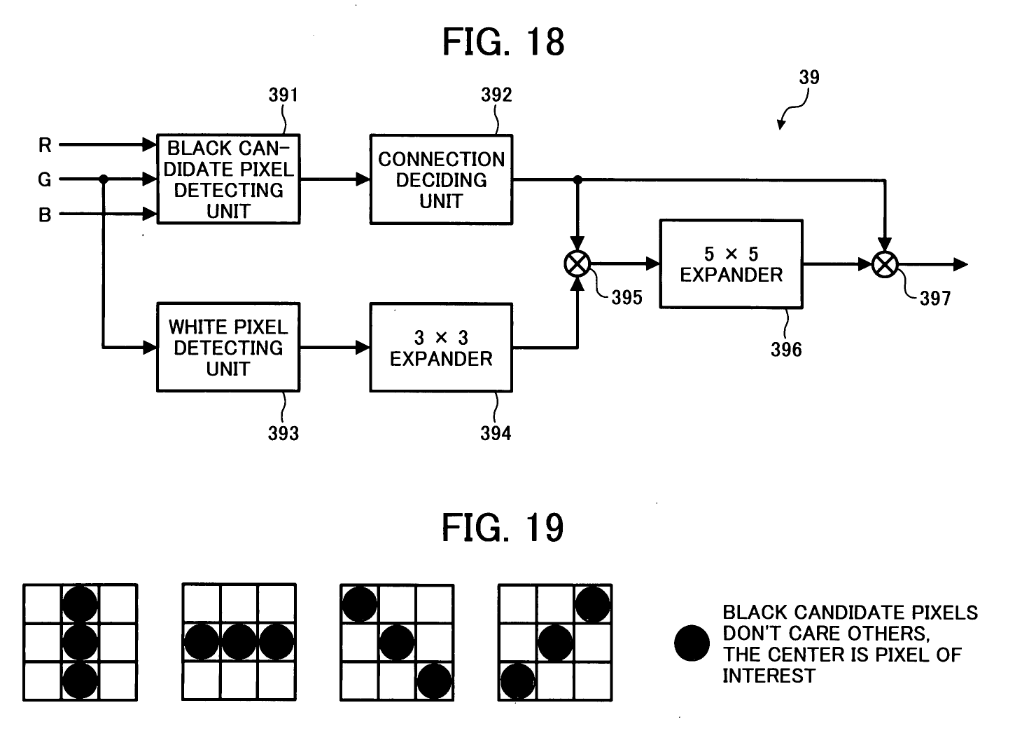

On the other hand, the code extracting unit 39 that extracts the black character edge detection result embedded by the code embedding unit 34 employs a structure as shown in FIG. 18. As illustrated, the code extracting unit 39 includes a black candidate pixel detecting unit 391, a connection deciding unit 392, a white pixel detecting unit 393, a 3×3 expander 394, a multiplier 395, a 5×5 expander 396, and a multiplier 397.

The black candidate pixel detecting unit 391 decides whether or not the pixel of interest satisfies R=G=B and G>th1 (th1 is a predetermined density threshold) for the RGB signals input from the expander 38, and when “yes,” a decision result indicating the black candidate pixel “1” is output to the connection deciding unit 392.

The connection deciding unit 392 performs pattern matching based on the pattern shown in FIG. 19 on the decision result input from the black candidate pixel detecting unit 391, and outputs the result of the pattern matching to the multipliers 395 and 397. In this pattern matching, three consecutive black pixels are detected containing the pixel of interest at the center in any one direction of the vertical, horizontal, and oblique directions so that an isolated pixel is removed. This uses the characteristics of the character image, where a black character identification signal is not present in isolation by 1 dot or 2 dots but is present as a block of the consecutive black pixels. For example, since a pattern matching using the characteristics is incorporated also in the image area separation unit disclosed in Japanese Patent Application Lid-Open No. 4-14378, when the detection has been performed in parallel with the image area separation at the front stage, the black character identification signal is not present in isolation.

On the other hand, the white pixel detecting unit 393 performs white image detection on the “G” signal input from the expander 38 and outputs the same to the 3×3 expander 394 in parallel with the black candidate pixel detection by the black candidate pixel detecting unit 391. As described above, the black character identification signal is an identification signal indicating a black character on white background, and white pixels are surely present around the black character. The characteristics are used to remove the black block similar to a black character dotted in the pattern. Specifically, the white pixel detection 143 decides whether or not the pixel of interest satisfies R=G=B and G<th2 (th2 is a predetermined density threshold), and when “yes,” a decision result indicating the white pixel “1” is output to the 3×3 expander 144.

The 3×3 expander 394 performs 3×3 expansion processing on the white pixel detected by the white pixel detecting unit 393, and when even one white pixel is present within the 3×3 pixels with the pixel of interest at the center, “1” is output to the multiplier 395. The multiplier 395 outputs the AND operation of the signals input from the connection deciding unit 392 and the 3×3 expander 394 to the 5×5 expander 396. Thus, 1 dot inside the character is detected at the black character edge adjacent to the white pixels. Since 1 dot is not sufficient for the black character identification signal required for processing the black character in consideration of the color offset amount of the printer, 3 dots are employed as follows.

The 5×5 expander 396 performs 5×5 expansion processing on the AND operation input from the multiplier 395, and outputs “1” to the multiplier 397 when even one “1” is present within the 3×3 pixels with the pixel of interest at the center. The multiplier 397 outputs the AND operation of the output of the 5×5 expander 396 and the output of the connection deciding unit 392 as the extracted black character identification signal. Thus, a black character decision can be made up to 3 dots inside the character, and the black character identification area for 2 dots on the white background can be removed by the 5×5 expander 396. In this manner, the white background is removed because an erroneously extracted area is reduced and degradation is minimized possibly even when the erroneously extracted area occurs as the black character in the pattern.

A program that causes the computer to execute the acquisition processing of the attribute signals, various correction processings on the attribute signals, and the processings containing the image processing according to the corrected attribute signals, which are performed in each embodiment, may be provided to the user via a communication line such as the Internet, and the program may be recorded in a computer readable recording medium such as a CD-ROM (Compact Disc-Read Only Memory) to be provided to the user.

As explained above, according to one embodiment of the invention, since an attribute signal indicating an attribute of image data is corrected to attribute signals indicating various different attributes and a plurality of image processings are performed based on each of the respective attribute signals, a suitable image processing can be performed according to various attributes of the image.

Moreover, since an attribute signal acquired from image data before being irreversibly compressed is corrected to attribute signals indicating various different attributes and an image processing is performed on the image data based on each of the corrected attribute signals, a suitable image processing can be performed according to various attributes of the image. Further, since the held attribute signal is corrected so that various attribute signals are obtained, various attribute signals does not require to be held so that the held data amount can be restricted.

Furthermore, since an attribute signal is corrected based on the image processing mode set by the mode setting unit and an image processing is performed on image data based on each corrected attribute signal, a suitable processing can be performed according to the mode.

Moreover, since an image processing is performed based on various attribute signals obtained by correcting an attribute signal indicating the character edge from image data, the attribute indicating the character edge is acquired from the image so that a suitable image processing can be performed according to various attributes of the image.

Furthermore, since an attribute signal indicating an attribute containing whether or not an image is the character inside area that is the pattern area inside the character edge area in the image is obtained from an attribute signal by the correcting, a suitable image processing can be performed according to whether or not the image is the character inside area

Moreover, since an attribute signal indicating an attribute containing a line width of an edge can be obtained by the correcting, a suitable image processing can be performed according to the line width of the edge.

Furthermore, since an attribute signal indicating an attribute containing a density of an image is obtained, a suitable image processing can be performed according to the density.

Moreover, since an attribute signal of image data before being irreversibly compressed is acquired, the attribute signal is embedded into the image data, and the image data into which the attribute signal is embedded is transmitted to an outside device, an image processing can be performed by extracting and utilizing the attribute signal in the outside device.

Furthermore, since an attribute signal acquired from image data before being irreversibly compressed is stored in correspondence to the image data, and the image data and an attribute signal in correspondence thereto are transmitted to an outside device, an image processing can be performed utilizing the attribute signal in the outside device.

Moreover, since an attribute signal indicating an attributes of image data is corrected to attribute signals indicating various different attributes and a plurality of image processings are performed based on each of the respective attribute signals, a suitable image processing can be performed according to various attributes of the image.

Furthermore, since an attribute signal acquired from image data before being irreversibly compressed is corrected to attribute signals indicating various different attributes and an image processing is performed on the image data based on each of the corrected attribute signals, a suitable image processing can be performed according to various attributes of the image. Further, since the held attribute signal is corrected so that various attribute signals are obtained, various attribute signals does not require to be held so that the held data amount can be restricted.

Moreover, since an attribute signals indicating an attributes of image data is corrected to attribute signals indicating various different attributes and a plurality of image processings are performed based on each of the respective attribute signals, a suitable image processing can be performed according to various attributes of the image.

Furthermore, since an attribute signal acquired from image data before being irreversibly compressed is corrected to attribute signals indicating various different attributes and an image processing is performed on the image data based on each of the corrected attribute signals, a suitable image processing can be performed according to various attributes of the image before being irreversibly compressed. Further, since the held attribute signal is corrected so that various attribute signals are obtained, various attribute signals does not require to be held so that the held data amount can be restricted.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. An image processing apparatus comprising:
an attribute acquiring unit to acquire an attribute signal that indicates an attribute of image data;
a correcting unit to correct the attribute signal to obtain a plurality of attribute signals each of which indicates an attribute different from the attribute indicated by the attribute signal; and
an image processing unit to perform a plurality of image processings on the image data based on each of the attribute signals obtained.

2. The image processing apparatus according to claim 1, further comprising a mode setting unit to set an image processing mode in which the image processing apparatus should operate from among the image processing modes for causing the image processing apparatus to perform an image processing suitable for each of a plurality of kinds of image contents,
wherein the correcting unit corrects the attribute signal based on the image processing mode set by the mode setting unit.

3. The image processing apparatus according to claim 1, wherein the attribute acquiring unit acquires an attribute signal indicating a character edge in an image corresponding to the image data.

4. The image processing apparatus according to claim 3, wherein the correcting unit corrects the attribute signal acquired by the attribute acquiring unit to signals that indicate attributes containing whether the image is a character inside area that is a pattern area inside a character edge area in the image.

5. The image processing apparatus according to claim 3, wherein the correcting unit corrects the attribute signal acquired by the attribute acquiring unit to signals indicating attributes containing a line width of an edge.

6. The image processing apparatus according to claim 3, wherein the correcting unit corrects the attribute signal acquired by the attribute acquiring unit to signals indicating attributes containing a density.

7. An image processing apparatus comprising:
a compression unit to irreversibly compress image data;
a storage unit to store the compressed image data;
an expansion unit to expand the compressed image data that is stored in the storage unit;
an attribute acquiring unit to acquire an attribute signal that indicates an attribute of the image data before being irreversibly compressed by the compressor;
a holding unit to hold the attribute signal acquired by the attribute acquiring unit;
a correcting unit to correct the attribute signal held by the holding unit to obtain a plurality of attribute signals each of which indicates an attribute different from the attribute indicated by the signal; and
an image processing unit to perform a plurality of image processings on the image data expanded by the expansion unit based on each of the attribute signals corrected by the correcting unit.

8. The image processing apparatus according to claim 7, further comprising a mode setting unit to set an image processing mode in which the image processing apparatus should operate from among the image processing modes for causing the image processing apparatus to perform an image processing suitable for each of a plurality of kinds of image contents,
wherein the correcting unit corrects the attribute signal based on the image processing mode set by the mode setting unit.

9. The image processing apparatus according to claim 7, wherein the attribute acquiring unit acquires an attribute signal indicating a character edge in an image corresponding to the image data.

10. The image processing apparatus according to claim 9, wherein the correcting unit corrects the attribute signal acquired by the attribute acquiring unit to signals that indicate attributes containing whether the image is a character inside area that is a pattern area inside a character edge area in the image.

11. The image processing apparatus according to claim 9, wherein the correcting unit corrects the attribute signal acquired by the attribute acquiring unit to signals indicating attributes containing a line width of an edge.

12. The image processing apparatus according to claim 9, wherein the correcting unit corrects the attribute signal acquired by the attribute acquiring unit to signals indicating attributes containing a density.

13. The image processing apparatus according to claim 7, further comprising:
an embedding unit to embed the attribute signal acquired by the attribute acquiring unit into the image data as extractable information; and
a transmitting unit to transmit the image data into which the attribute signal is embedded to an outside device.

14. The image processing apparatus according to claim 7, wherein the storage unit stores the attribute signal acquired by the attribute acquiring unit in correspondence to the image data, and
the image processing apparatus further comprises a transmitting unit to transmit the image data and the attribute signal stored in correspondence to the image data to an outside device.

15. An image processing method comprising:
acquiring an attribute signal that indicates an attribute of image data;
correcting the attribute signal to obtain a plurality of attribute signals each of which indicates an attribute different from the attribute indicated by the attribute signal; and
performing a plurality of image processings on the image data based on each of the attribute signals obtained.

16. An image processing method comprising:
acquiring an attribute signal indicating an attribute of image data before being irreversibly compressed;
irreversibly compressing the image data;
storing the irreversibly compressed image data;
holding the attribute signal acquired in the acquiring;
expanding the stored irreversibly compressed image data;
correcting the attribute signal held in the holding to obtain a plurality of attribute signals each of which indicates an attribute different from the attribute indicated by the signal; and
performing a plurality of image processings on the image data expanded in the expanding based on each of the attribute signals obtained in the correcting.

17. An article of manufacture having one or more recordable medium storing instructions thereon which, when executed by a computer, cause the computer to:
acquire an attribute signal that indicates an attribute of image data;
correct the attribute signal to obtain a plurality of attribute signals each of which indicates an attribute different from the attribute indicated by the attribute signal; and
perform a plurality of image processings on the image data based on each of the attribute signals obtained.

18. An article of manufacture having one or more recordable medium storing instructions thereon which, when executed by a computer, cause the computer to:
acquire an attribute signal indicating an attribute of image data before being irreversibly compressed;
irreversibly compress the image data;
store the irreversibly compressed image data;
hold the attribute signal acquired in the acquiring;
expand the stored irreversibly compressed image data;
correct the attribute signal held in the holding to obtain a plurality of attribute signals each of which indicates an attribute different from the attribute indicated by the signal; and
perform a plurality of image processings on the image data expanded in the expanding based on each of the attribute signals obtained in the correcting.
